(19) United States
(12) Patent Application Publication
(10) Pub. No.: US 2025/0062922 A1
(43) Pub. Date: Feb. 20, 2025

(54) HIGHLY AVAILABLE, VERIFIABLE, AND DECENTRALIZED WEBSOCKET SUBSCRIPTIONS FOR BLOCKCHAIN NETWORKS

(71) Applicant: VMware LLC, Palo Alto, CA (US)

(72) Inventors: Bala Siva Sai Akhil Malepati, Sunnyvale, CA (US); Rachit Chadha, Santa Clara, CA (US); Ram Krishnan, Cupertino, CA (US)

(21) Appl. No.: 18/452,464

(22) Filed: Aug. 18, 2023

(51) Int. Cl. H04L 9/00; H04L 9/30; H04L 9/32

(52) U.S. Cl. CPC H04L 9/50; H04L 9/30; H04L 9/3247

(57) ABSTRACT

Techniques for implementing highly available, verifiable, and decentralized WebSocket subscriptions for a blockchain network are provided. In one set of embodiments, these techniques include maintaining, by the replicas of the blockchain network, identical copies of the metadata (i.e., artifacts) for the network's WebSocket subscriptions and digitally signing, by the replicas, all subscription-related responses. With this approach, the subscribers of the WebSocket subscriptions can verify that the responses they receive are authentic by verifying the included signatures. Further, because the subscription artifacts are maintained as shared state across the replicas, there is no single point of failure or centralized trust for the subscriptions, resulting in improved fault tolerance and security.

### BACKGROUND

Unless specifically indicated herein, the approaches described in this section should not be construed as prior art to the claims of the present application and are not admitted to be prior art by inclusion in this section.

A blockchain is a distributed ledger of data that is maintained by a peer-to-peer computer network, called a blockchain network. A typical blockchain network comprises two types of nodes: client nodes and replicas. The client nodes act as an interface between the replicas and external client applications, referred to as distributed applications or “dapps.” The replicas maintain copies of the blockchain and process client requests submitted by the dapps, resulting in the addition of new blocks (which hold committed transaction records) to the blockchain. To ensure that their respective copies of the blockchain remain consistent, the replicas employ a consensus protocol that controls the order in which client requests are processed (and thus, the order in which blockchain blocks are added). This consensus protocol is usually a Byzantine fault tolerant (BFT) protocol, which enables consensus to be reached in the face of up to f Byzantine replicas (i.e., faulty/corrupted replicas that can exhibit arbitrary behavior). The specific consensus protocol employed, as well as other implementation details and features of the blockchain network, are determined by the network's blockchain platform. Examples of well-known blockchain platforms include Ethereum, Hyperledger Fabric, and Quorum.

Several blockchain platforms support a feature known as WebSocket subscriptions, which provides dapps with real-time updates regarding changes (i.e., events) that are observed on a blockchain. This allows the dapps to be immediately notified whenever certain blockchain events occur, without having to constantly poll for that information. However, current implementations of this feature suffer from various shortcomings, such as an inability to verify received updates, poor fault tolerance, a need for centralized trust, and an inability to gracefully handle dapp restarts. These shortcomings significantly limit the usefulness of WebSocket subscriptions in many business scenarios.

### BRIEF DESCRIPTION OF THE DRAWINGS

FIG. 1 depicts an example environment comprising a blockchain client and a blockchain network.

FIGS. 2A and 2B depict a workflow for creating a WebSocket subscription and delivering event messages for the subscription in the environment of FIG. 1 according to certain embodiments.

FIG. 3 depicts a subscription creation flowchart according to certain embodiments.

FIG. 4 depicts an event delivery flowchart according to certain embodiments.

FIG. 5 depicts a resubscription flowchart according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

Embodiments of the present disclosure are directed to techniques for implementing highly available, verifiable, and decentralized WebSocket subscriptions for a blockchain network. Generally speaking, these techniques involve maintaining, by the replicas of the blockchain network, identical copies of the metadata (i.e., artifacts) for the network's WebSocket subscriptions and digitally signing, by the replicas, all subscription-related responses (e.g., event messages, etc.). With this approach, the subscribers of the WebSocket subscriptions can verify that the responses they receive are authentic by verifying the included signatures. Further, because the subscription artifacts are maintained as shared state across the replicas, there is no single point of failure or centralized trust for the subscriptions, resulting in improved fault tolerance and security.

### 1. Example Environment and Solution Overview

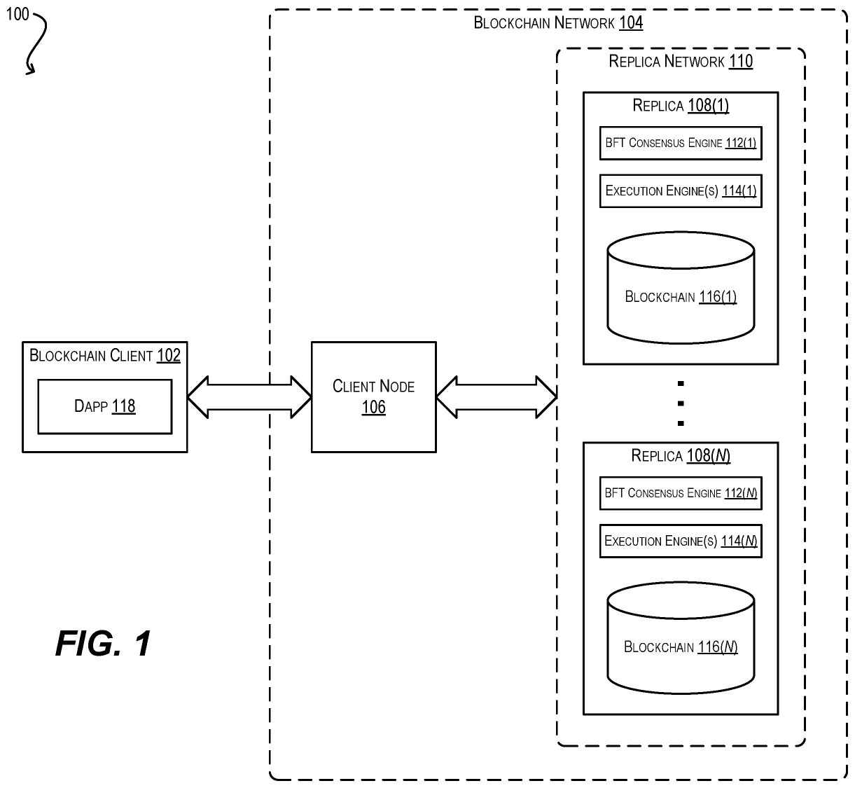

FIG. 1 depicts an example environment 100 in which the techniques of the present disclosure may be employed. Environment 100 includes a blockchain client 102 that is communicatively coupled with a blockchain network 104 comprising a client node 106 and N replicas 108(1)-(N) (which collectively form a replica network 110 within blockchain network 104). Although only a single blockchain client and a single client node are depicted for simplicity of illustration, any number of these entities may be present within environment 100.

As shown in FIG. 1, each replica 108 includes a BFT consensus engine 112, one or more execution engines 114, and a copy of the blockchain maintained by blockchain network 104 (reference numeral 116). The replicas use their respective BFT consensus engines to reach agreement (via a BFT protocol) on the execution sequence of incoming client requests, and use their respective execution engine(s) to execute those requests in the agreed-upon sequence. As mentioned previously, a BFT protocol can tolerate up to f faulty/corrupted replicas.

In addition, blockchain client 102 includes a dapp 118, which is a software application that is configured to access blockchain network 104—or more precisely, blockchain 116 maintained by blockchain network 104—in order to implement some functionality. For example, blockchain 116 may hold transaction records pertaining to non-fungible tokens (NFTs) and dapp 118 may be an NFT wallet application.

For the purposes of this disclosure, it is assumed that dapp 118 wishes to receive real-time notifications of certain events occurring on blockchain 116 via a WebSocket subscription. For example, dapp 118 may wish to be notified when a new block is added to blockchain 116, when a new pending transaction is received, when a smart contract is executed, when a log record for a block is created, or the like. WebSocket subscriptions enable such notifications (referred to as event messages) to be efficiently delivered to subscribers by eliminating the need for continuous polling.

There are several existing implementations of the WebSocket subscriptions feature, although they are mostly similar in design. The following is a high-level description of steps that may be carried out by dapp 118 and client node 106 for creating a WebSocket subscription S on blockchain network 104 and delivering event messages for S to dapp 118 according to one conventional implementation:
1. Dapp 118 establishes a WebSocket connection C to client node 106, which is a persistent (i.e., long-lived), bidirectional network connection that utilizes Transmission Control Protocol (TCP).
2. Dapp 118 invokes, over connection C, a subscription application programming interface API, referred to as a subscribe API, for creating subscription S on blockchain network 104. This subscribe API is part of a blockchain remote procedure call (RPC) interface exposed by client node 106 that allows external entities to interact with blockchain network 104. For example, in the scenario where blockchain network 104 implements the Ethereum blockchain platform, this interface may be the EthRPC interface and the subscribe API may be eth_subscribe. The invocation of the subscribe API includes a set of subscription parameters that specify the type of blockchain event dapp 118 wishes to subscribe to (e.g., addition of new blocks, creation of log records, etc.). The subscription parameters may also specify one or more filters that further narrow down the event type according to various criteria (e.g., creation of log records associated with a particular block B).
3. Client node 106 receives the subscribe API invocation and creates subscription S by assigning a new subscription identifier (ID) to S, creating a new subscription artifact for S that includes the subscription ID, the received subscription parameters, and other metadata (e.g., a subscription creation timestamp), and persisting the subscription artifact locally on the client node.
4. Client node 106 returns the subscription ID to dapp 118 over connection C, thereby confirming that subscription S has been created.
5. Upon detecting a new event on blockchain 116 that matches the parameters of subscription S (as recorded in the subscription artifact), client node 106 packages information regarding the event (along with the subscription ID of S) into an event message and sends the event message over connection C to dapp 118.
6. Dapp 118 receives and processes the event message in accordance with its design.
7. Steps (5) and (6) repeat until dapp 118 invokes an unsubscribe API exposed by client node 106 for removing subscription S or until connection C is closed. In the scenario where connection C is closed (due to, e.g., a network error or a failure or restart of dapp 118 or client node 106), subscription S is automatically deleted by client node 106.

As indicated in the Background section, while this conventional WebSocket subscriptions implementation is functional, it also suffers from several problems. First, this implementation does not provide any way for dapp 118 to verify that the subscription-related responses it receives from client node 106 over connection C are authentic, or in other words originate from blockchain network 104 and are untampered with. This is problematic because dapp 118 (or an end-user of the dapp) may rely on these responses in order to make important business decisions, such as initiating a financial transaction or the like.

Second, because the artifact for subscription S is maintained solely by client node 106, the client node acts as a single point of failure and a centralized point of trust for S, which are both undesirable. For example, if client node 106 goes offline due to, e.g., a hardware or software failure, it cannot deliver any events for subscription S to dapp 118 during that downtime. As another example, if client node 106 is attacked by an adversary, the integrity of subscription S (as well as all other subscriptions maintained by client node 106) will be compromised.

Third, in a scenario where dapp 118 fails and is restarted, this conventional implementation does not provide a mechanism for gracefully resuming the operation of subscription S. Instead, as noted above, subscription S will be automatically deleted by client node 106 once dapp 118 is unreachable (because that will cause connection C to be closed), which means dapp 118 must recreate S upon being restarted if it wishes to continue receiving messages for the events defined by this subscription. Further, even if dapp 118 recreates subscription S upon restart, dapp 118 will not receive any prior event messages for S that client node 106 attempted to send while the dapp was down; those prior event messages will be permanently “lost” and thus will never reach dapp 118.

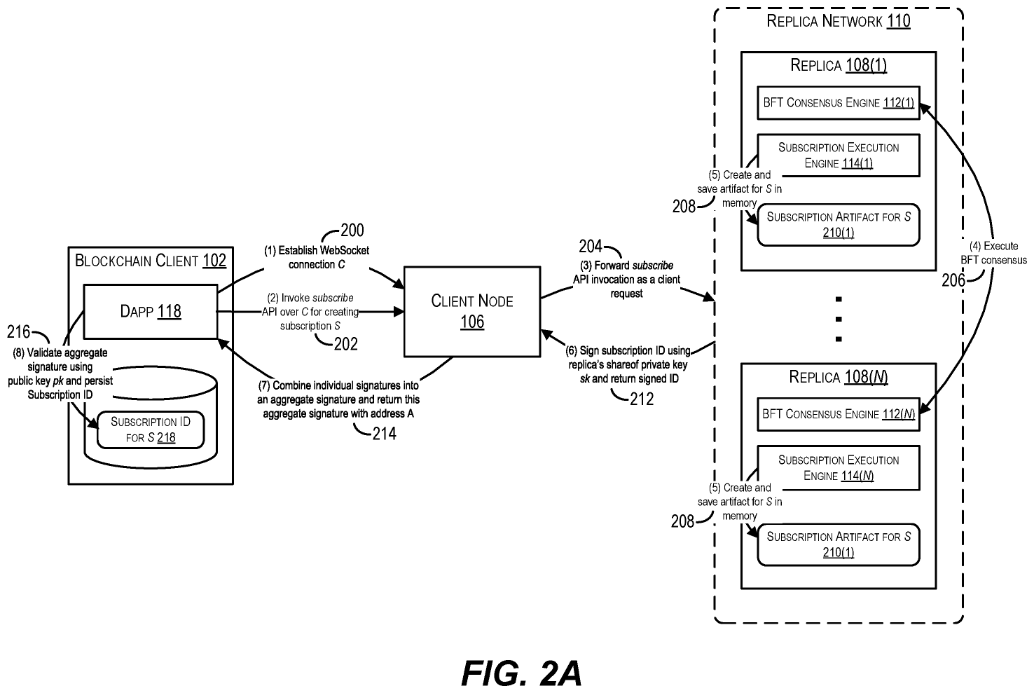

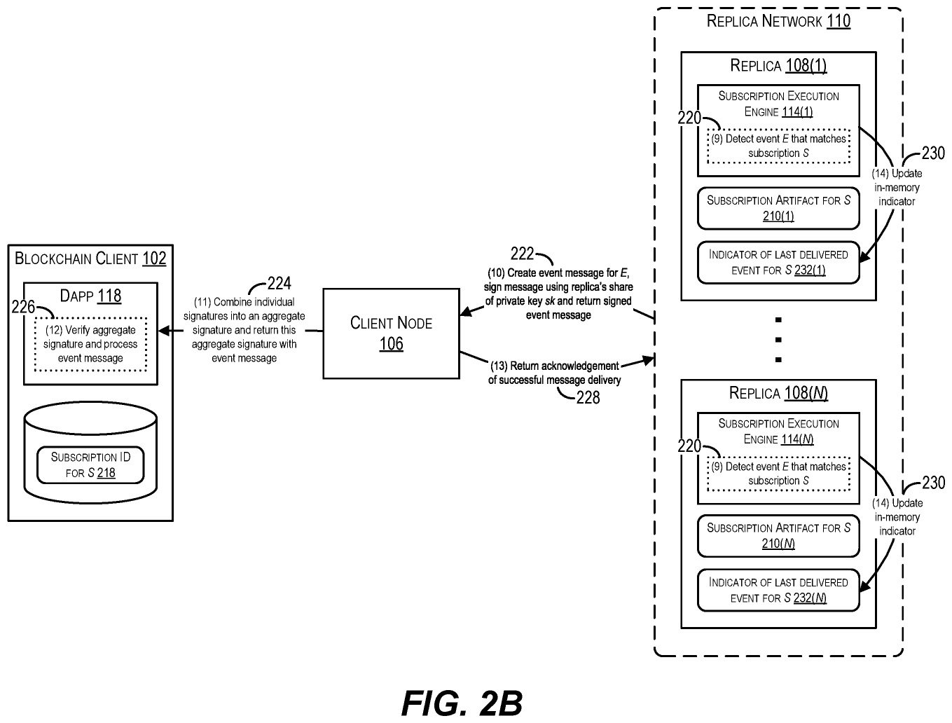

To address the foregoing and other related issues, FIGS. 2A and 2B depict an improved Web Socket subscriptions implementation according to embodiments of the present disclosure, and more particularly an improved workflow that may be executed by dapp 118 and blockchain network 104 for creating subscription S and delivering event messages for S to dapp 118. This workflow assumes that each replica 108 includes a subscription execution engine 114 that is designed to handle subscription processing. The workflow also assumes (but does not require) that blockchain network 104 is a permissioned network with a relatively small number of replicas, as the mechanics of this solution work best in such a setting.

Starting with FIG. 2A, at steps (1) and (2) (reference numerals 200 and 202), dapp 118 can establish a WebSocket connection C to client node 106 and invoke, over connection C, a subscribe API for creating subscription S on blockchain network 104. These steps are largely similar to steps (1) and (2) of the conventional implementation described above.

At step (3) (reference numeral 204), client node 106 can forward the subscribe API invocation as a client request to replicas 108(1)-(N), rather than handling it locally. In response, replicas 108(1)-(N) can agree upon an execution sequence number for processing the client request via their BFT consensus engines (step (4); reference numeral 206) and, once the agreed-upon execution sequence number is reached, the subscription execution engine of each replica 108 can execute the client request by creating an artifact for subscription S (which includes, e.g., a subscription ID and the subscription parameters from the original subscribe API invocation) and saving the created subscription artifact in local volatile memory (e.g., RAM) (step (5); reference numeral 208). The in-memory instance of this artifact is shown via reference numeral 210.

The subscription execution engine of each replica 108 can then sign the subscription ID for subscription S using a portion (i.e., share) of a private key sk that is uniquely assigned to, and only known by, that specific replica, and can provide the signed subscription ID to client node 106 (step (6); reference numeral 212). These per-replica shares of private key sk are denoted herein as sk₁, . . . , sk_{N} and are generated via a (t, N) threshold signature scheme where t=f.

Upon receiving signed subscription IDs from at least f+1 replicas, client node 106 can combine the individual signatures into an aggregate signature in accordance with the (t, N) threshold signature scheme and can return the aggregate signature with the subscription ID to dapp 118 over connection C (step (7); reference numeral 214). Finally, at step (8) (reference numeral 216), dapp 118 can verify whether the aggregate signature is valid using a public key pk that is the public key counterpart of private key sk and, upon successfully completing this signature verification, can persist the subscription ID (shown via reference numeral 218). At this point, subscription S is established and active.

Turning now to FIG. 2B, at step (9) (reference numeral 220), the subscription execution engine of each replica 108 can detect the occurrence of an event E on blockchain 116 that matches the parameters of subscription S. In response, the subscription execution engine can create an event message that includes information regarding E (along with the subscription ID of S), sign the event message using the replica's share of private key sk, and send the signed event message to client node 106 (step (10); reference numeral 222).

Upon receiving signed event messages from at least f+1 replicas, client node 106 can combine the individual signatures into an aggregate signature in accordance with the (t, N) threshold signature scheme and can send the aggregate signature with the event message to dapp 118 over connection C (step (11); reference numeral 224). At step (12) (reference numeral 226), dapp 118 can receive this information, verify whether the aggregate signature is valid using public key pk, and assuming the verification is successful, process the event message.

Concurrently with step (12), client node 106 can check whether the aggregate signature and event message sent at step (11) was successfully delivered to dapp 118 and, if the answer is yes, can transmit an acknowledgement of successful delivery to replicas 108(1)-(N) (step (13); reference numeral 228).

Finally, at step (14) (reference numeral 230), the subscription execution engine of each replica 108 can receive the acknowledgement and update an in-memory indicator associated with subscription S (shown via reference numeral 232) to identify event E as the last event successfully delivered to dapp 118. Steps (9)-(14) can subsequently be repeated to handle future events that match subscription S. In one set of embodiments, in-memory indicator 232 can include a “last block number” that specifies a block number of blockchain 116 that is associated with event E. In other embodiments, this in-memory indicator can include any other type of information that replica 108 may use to identify E as the last-delivered event.

With the improved WebSocket subscriptions implementation shown in FIGS. 2A and 2B and described above, a number of advantages are realized. First, because the artifact for subscription S is replicated across replicas 108(1)-(N) rather than being held solely by client node 106, there is no single point of failure for S. In fact, up to f replicas of blockchain network 104 may fail (in accordance with the fault tolerance limit of the network's BFT protocol) without affecting the delivery of subscription S to dapp 118. In the case where a replica temporarily goes offline for whatever reason, that replica can automatically fetch the subscription artifacts held by the other replicas upon restart, thereby ensuring that all active replicas maintain the same subscription state. This configuration also means that dapp 118 does not need to trust a centralized entity to safeguard the subscription artifacts; instead, trust is decentralized across replicas 108(1)-(N). Such decentralization is particularly useful if, for example, each replica is owned by a different organization in a federation of organizations.

Second, because the artifact for subscription S is held in the volatile memory of each replica 108, the artifact does not consume any storage space on blockchain 116 and does not require I/O operations on the blockchain for creating, updating, or deleting the subscription.

Third, because all subscription responses delivered to dapp 118 are signed by the replicas of blockchain network 104, dapp 118 can verify that the responses are authentic using the network's corresponding public key and thereby overcome any security concerns regarding message forgery or tampering. In some embodiments, rather than signing the responses using a per-replica share of private key sk, each replica 108 may sign the responses using a common private key and client node 106 can simply forward this signature to dapp 118, rather than generating an aggregate signature.

Fourth, because (1) each replica 108 maintains an in-memory indicator of the last event it delivered to dapp 118 for subscription S and (2) dapp 118 locally stores S's subscription ID, the previously mentioned problems that may arise due to a restart of dapp 118 can be avoided. For example, in the case where dapp 118 fails and is restarted while subscription S is active, dapp 118 can use its locally-stored subscription ID to send a request to client node 106 for re-subscribing to subscription S. In response, client node 106 can forward this resubscription request to replicas 108(1)-(N), and each replica 108 can serve to dapp 118 the events for subscription S that occurred since the last delivered event (as specified by the replica's in-memory indicator 232). This advantageously avoids the need for dapp 118 to create a brand new, identical subscription upon restart, and also ensures that dapp 118 receives all pending event messages for subscription S, including those that could not be delivered while the dapp was down.

It should be appreciated that these FIGS. 1, 2A, and 2B and the foregoing description are illustrative and not intended to limit the embodiments presented herein. For example, although FIGS. 2A and 2B pertain to an improved WebSocket subscriptions implementation, the same principles may be applied to other types of blockchain subscription mechanisms, such as subscriptions that are created via Ethereum Hypertext Transfer Protocol (HTTP) filter APIs.

Further, although the foregoing figures depict a particular arrangement of entities in environment 100, other arrangements are possible (e.g., the functionality attributed to a particular entity may be split into multiple entities, entities may be combined, etc.). One of ordinary skill in the art will recognize other variations, modifications, and alternatives.

### 2. Subscription Creation

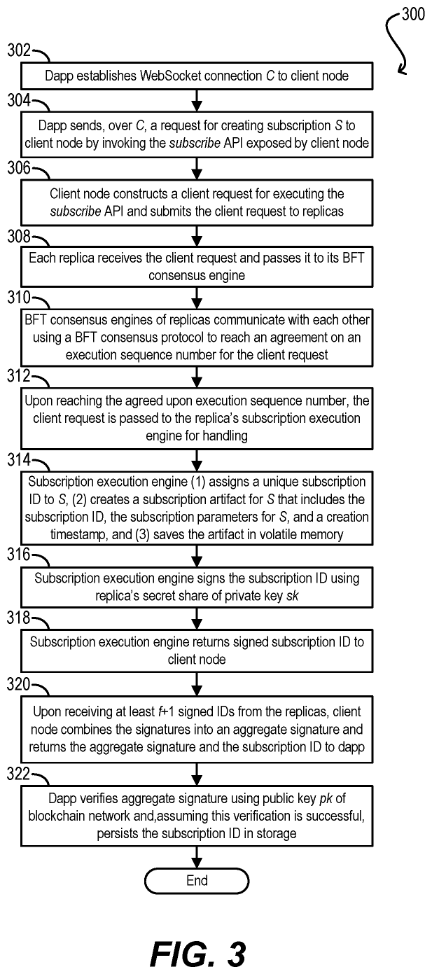

FIG. 3 depicts a flowchart 300 that may be performed dapp 118 and blockchain network 104 for creating WebSocket subscription S (per steps (1)-(8) of FIG. 2A) according to certain embodiments.

Starting with blocks 302 and 304, dapp 118 can establish a WebSocket connection C to client node 106 and can send a request over this connection to create subscription S by invoking a subscribe API exposed by the client node. As mentioned previously, the subscribe API invocation can include a set of subscription parameters specifying the type of blockchain event(s) that dapp 118 wishes to subscribe to.

Upon receiving the invocation, client node 106 can construct a client request for executing the subscribe API and can submit the request to replicas 108(1)-(N) of blockchain network 104 (block 306).

At block 308, each replica 108 can receive the client request and pass it to its BFT consensus engine 112. The BFT consensus engines can then agree upon an execution sequence number for the client request (block 310) and once this sequence number is reached, the request can be passed to the replica's subscription execution engine 114 for handling (block 312).

At block 314, subscription execution engine 114 can assign a unique subscription ID to subscription S, create a subscription artifact for S that includes the subscription ID, the subscription parameters specified by dapp 118, and a creation timestamp, and save the created artifact in a local volatile memory of the replica. Further, at block 316, subscription execution engine 114 can sign the subscription ID using the replica's share skᵢ of private key sk. Subscription execution engine 114 can subsequently return the signed subscription ID to client node 106 (block 318).

Upon receiving at least f+1 signed subscription IDs from the replicas, client node 106 can combine the signatures in the received messages into an aggregate signature and can return the subscription ID and the aggregate signature to dapp 118 over connection C (block 320). Dapp 118 can then verify the aggregate signature using public key pk of blockchain network 104 and, assuming this verification is successful, can persist the subscription ID in storage (block 322). For example, dapp 118 may persist the subscription ID in a local storage of blockchain client 102 or some other storage location accessible to the client.

### 3. Event Message Delivery

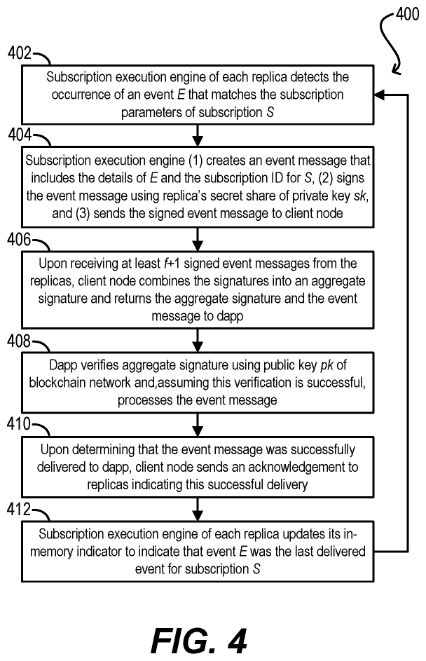

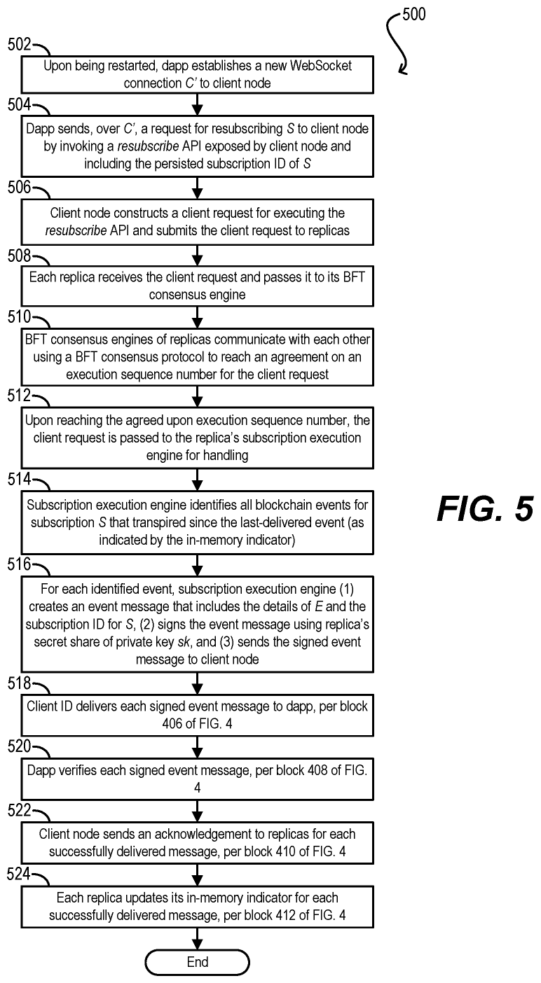

FIG. 4 depicts a flowchart 400 that may be performed dapp 118 and blockchain network 104 for delivering event messages for subscription S to dapp 118 (per steps (9)-(14) of FIG. 2B) according to certain embodiments. Flowchart 400 assumes that subscription 400 has been created in accordance with flowchart 300 of FIG. 3 and is active/healthy.

Starting with block 402, subscription execution engine 114 of each replica 108 can detect the occurrence of an event E on blockchain 116 that matches the subscription parameters of subscription S. In response, engine 114 can create an event message that includes the details of event E and the subscription ID of S, sign the event message using the replica's share of private key sk, and send the signed event message to client node 106 (block 404).

Upon receiving at least f+1 signed event messages from the replicas, client node 106 can combine the signatures in the received messages into an aggregate signature and can return the event message and the aggregate signature to dapp 118 over connection C (block 406). Dapp 118 can then verify the aggregate signature using public key pk of blockchain network 104 and, assuming this verification is successful, can process the event message in accordance with its design (block 408).

In addition, upon determining that the event message was successfully delivered to dapp 118, client node 108 can send an acknowledgement to replicas 108(1)-(N) indicating this successful delivery (block 410). In response, the subscription execution engine of each replica 108 can update its in-memory indicator 232 to indicate that event E was the last delivered event for subscription S (block 412). Finally, flowchart 400 can return to block 402 in order to handle the next event for S.

4. Resubscription after Dapp Restart

FIG. 5 depicts a flowchart 500 that enables dapp 118 to resubscribe to subscription S according to certain embodiments. Flowchart 500 assumes that dapp 118 fails or otherwise goes offline (while subscription S is active) and is subsequently restarted.

Starting with blocks 502 and 504, upon being restarted, dapp 118 can establish a new WebSocket connection C′ to client node 106 and can send a request over this connection to resubscribe to subscription S by invoking a resubscribe API exposed by the client node. This resubscribe API invocation can include the subscription ID of S that dapp 118 persisted at block 326 of flowchart 300.

Upon receiving the invocation, client node 106 can construct a client request for executing the resubscribe API and can submit the request to replicas 108(1)-(N) of blockchain network 104 (block 506).

At block 508, each replica 108 can receive the client request and pass it to its BFT consensus engine 112. The BFT consensus engines can then agree upon an execution sequence number for the client request (block 510) and once this sequence number is reached, the request can be passed to the replica's subscription execution engine 114 for handling (block 512).

At block 514, subscription execution engine 114 can receive the request and identify all blockchain events for subscription S that have transpired since the last-delivered event (as indicated by its in-memory indicator 232). For each such event, subscription execution engine 114 can create an event message that includes the details of the event and the subscription ID of S, sign the event message using the replica's share of private key sk, and send the signed event message to client node 106 (block 516).

Client node 106 can then deliver each signed event message to dapp 118 (block 518), and dapp 118 can verify each signed message (block 520), in a manner similar to blocks 406 and 408 of flowchart 400. Finally, client node 106 can send acknowledgements to replicas 108(1)-(N) indicating the successful delivery of these event messages to dapp 118 (block 522), and the replicas can update their respective in-memory indicators accordingly (block 524), in a manner similar to blocks 410 and 412 of flowchart 400.

Certain embodiments described herein can employ various computer-implemented operations involving data stored in computer systems. For example, these operations can require physical manipulation of physical quantities-usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
receiving, by a replica in a set of N replicas that are part of a blockchain network, a request to create a subscription, the request including a set of parameters specifying one or more types of blockchain events;
assigning, by the replica, a unique subscription identifier (ID) to the subscription;
creating, by the replica, a subscription artifact for the subscription that includes the subscription ID and the set of parameters;
saving, by the replica, the subscription artifact in a volatile memory of the replica;
signing, by the replica, the subscription ID using a share of a private key of the blockchain network that is assigned to the replica, the share being known only to the replica and being unknown to other replicas in the set of N replicas; and
outputting, by the replica, the signed subscription ID.

2. The method of claim 1 wherein the blockchain network implements a Byzantine fault tolerant (BFT) consensus protocol that tolerates up to f faulty replicas, and wherein the shares of the private key assigned to the set of N replicas are generated using a (t, N) threshold signature scheme where t=f.

3. The method of claim 1 wherein the request originates from a distributed application (dapp), and wherein a client node of the blockchain network:
receives signed subscription IDs from the set of N replicas;
combines signatures included in the signed subscription IDs into an aggregate signature; and
sends the subscription ID and the aggregate signature to the dapp.

4. The method of claim 3 wherein upon receiving the subscription ID and the aggregate signature from the client node, the dapp:
verifies that the aggregate signature is valid using a public key corresponding to the private key; and
persists the subscription ID in a storage accessible to the dapp.

5. The method of claim 1 further comprising:
detecting an occurrence of a blockchain event that matches the set of parameters;
creating an event message that includes information regarding the blockchain event and the subscription ID;
signing the event message using the share of the private key that is assigned to the replica; and
outputting the signed event message.

6. The method of claim 5 further comprising:
receiving an acknowledgement that the signed event message was successfully delivered to a subscriber of the subscription; and
updating an indicator maintained in the volatile memory to indicate that the detected blockchain event was a last-delivered event for the subscription.

7. The method of claim 6 further comprising:
receiving a request to resubscribe to the subscription;
identifying all blockchain events that transpired since the last-delivered event as recorded via the indicator; and
for each identified blockchain event:
creating an event message that includes information regarding said each identified blockchain event and the subscription ID;
signing the event message using the share of the private key that is assigned to the replica; and
outputting the signed event message.

8. A non-transitory computer readable storage medium having stored thereon program code executable by a replica in a set of N replicas that are part of a blockchain network, the method comprising:
receiving a request to create a subscription, the request including a set of parameters specifying one or more types of blockchain events;
assigning a unique subscription identifier (ID) to the subscription;
creating a subscription artifact for the subscription that includes the subscription ID and the set of parameters;
saving the subscription artifact in a volatile memory of the replica;
signing the subscription ID using a share of a private key of the blockchain network that is assigned to the replica, the share being known only to the replica and being unknown to other replicas in the set of N replicas; and
outputting the signed subscription ID.

9. The non-transitory computer readable storage medium of claim 8 wherein the blockchain network implements a Byzantine fault tolerant (BFT) consensus protocol that tolerates up to f faulty replicas, and wherein the shares of the private key assigned to the set of N replicas are generated using a (t, N) threshold signature scheme where t=f.

10. The non-transitory computer readable storage medium of claim 8 wherein the request originates from a distributed application (dapp), and wherein a client node of the blockchain network:
receives signed subscription IDs from the set of N replicas;
combines signatures included in the signed subscription IDs into an aggregate signature; and
sends the subscription ID and the aggregate signature to the dapp.

11. The non-transitory computer readable storage medium of claim 10 wherein upon receiving the subscription ID and the aggregate signature from the client node, the dapp:
verifies that the aggregate signature is valid using a public key corresponding to the private key; and
persists the subscription ID in a storage accessible to the dapp.

12. The non-transitory computer readable storage medium of claim 8 wherein the method further comprises:
detecting an occurrence of a blockchain event that matches the set of parameters;
creating an event message that includes information regarding the blockchain event and the subscription ID;
signing the event message using the share of the private key that is assigned to the replica; and
outputting the signed event message.

13. The non-transitory computer readable storage medium of claim 12 wherein the method further comprises:
receiving an acknowledgement that the signed event message was successfully delivered to a subscriber of the subscription; and
updating an indicator maintained in the volatile memory to indicate that the detected blockchain event was a last-delivered event for the subscription.

14. The non-transitory computer readable storage medium of claim 13 wherein the method further comprises:
receiving a request to resubscribe to the subscription;
identifying all blockchain events that transpired since the last-delivered event as recorded via the indicator; and
for each identified blockchain event:
creating an event message that includes information regarding said each identified blockchain event and the subscription ID;
signing the event message using the share of the private key that is assigned to the replica; and
outputting the signed event message.

15. A computer system acting as a replica in a set of N replicas that are part of a blockchain network, the computer system comprising:
a processor; and
a non-transitory computer readable medium having stored thereon program code that, when executed, causes the processor to:
receive a request to create a subscription, the request including a set of parameters specifying one or more types of blockchain events;
assign a unique subscription identifier (ID) to the subscription;
create a subscription artifact for the subscription that includes the subscription ID and the set of parameters;
save the subscription artifact in a volatile memory of the replica;
sign the subscription ID using a share of a private key of the blockchain network that is assigned to the replica, the share being known only to the replica and being unknown to other replicas in the set of N replicas; and
output the signed subscription ID.

16. The computer system of claim 15 wherein the blockchain network implements a Byzantine fault tolerant (BFT) consensus protocol that tolerates up to f faulty replicas, and wherein the shares of the private key assigned to the set of N replicas are generated using a (t, N) threshold signature scheme where t=f.

17. The computer system of claim 15 wherein the request originates from a distributed application (dapp), and wherein a client node of the blockchain network:
receives signed subscription IDs from the set of N replicas;
combines signatures included in the signed subscription IDs into an aggregate signature; and
sends the subscription ID and the aggregate signature to the dapp.

18. The computer system of claim 17 wherein upon receiving the subscription ID and the aggregate signature from the client node, the dapp:
verifies that the aggregate signature is valid using a public key corresponding to the private key; and
persists the subscription ID in a storage accessible to the dapp.

19. The computer system of claim 15 wherein the program code further causes the processor to:
detect an occurrence of a blockchain event that matches the set of parameters;
create an event message that includes information regarding the blockchain event and the subscription ID;
sign the event message using the share of the private key that is assigned to the replica; and
output the signed event message.

20. The computer system of claim 19 wherein the program code further causes the processor to:
receive an acknowledgement that the signed event message was successfully delivered to a subscriber of the subscription; and
update an indicator maintained in the volatile memory to indicate that the detected blockchain event was a last-delivered event for the subscription.

21. The computer system of claim 20 wherein the program code further causes the processor to:
receive a request to resubscribe to the subscription;
identify all blockchain events that transpired since the last-delivered event as recorded via the indicator; and
for each identified blockchain event:
create an event message that includes information regarding said each identified blockchain event and the subscription ID;
sign the event message using the share of the private key that is assigned to the replica; and
output the signed event message.
